(19) United States
(12) Patent Application Publication
(10) Pub. No.: US 2008/0303482 A1
(43) Pub. Date: Dec. 11, 2008

(54) Multi charging current control circuit and method thereof

(75) Inventors: Chih-Shih Yang, Hsinchu (TW); Ying-Lei Lee, Hsinchu County (TW)

Correspondence Address: RABIN & Berdo, PC, 1101 14TH STREET, NW, SUITE 500, WASHINGTON, DC, 20005, US

(73) Assignee: Prolific Technology Inc., Taipei (TW)

(21) Appl. No.: 12/007,628

(22) Filed: Jan. 14, 2008

(30) Foreign Application Priority Data
Jun. 5, 2007 (TW) 96120226

(51) Int. Cl. H02J 7/00

(52) U.S. Cl. 320/125; 320/162; 320/160

(57) ABSTRACT

A multi charging current control circuit including a voltage reference unit, a current limiting unit, a current detector and a current control unit is provided. The voltage reference unit provides many reference voltages. The current limiting unit selects a corresponding reference voltage from the reference voltages according to a charge mode signal and outputs a control signal according to the corresponding reference voltage. The current detector detects a first and a second charging current. The current control unit controls the first charging current and the second charging current according to the control signal. The current detector feedbacks the first charging current and the second charging current detected to the current control unit, such that the current control unit adjusts the first charging current or the second charging current to make the sum of the first charging current and the second charging current less than or equal to a constant value.

This application claims the benefit of Taiwan application Serial No. 96120226, filed Jun. 5, 2007, the subject matter of which is incorporated herein by reference.

### BACKGROUND OF THE INVENTION

1. Field of the Invention

The invention relates in general to a multi charging current control circuit and a method thereof, and more particularly to a functional and safe multi charging current control circuit and a method thereof.

2. Description of the Related Art

Referring to FIG. 1, a perspective of conventional charging circuit is shown. The charging circuit 100 includes a power supply 110, a current control circuit 120, a first power element 132, a first energy storage element 142, a first current sensor 152, a second power element 134, a second energy storage element 144 and a second current sensor 154. The power supply 110 drives the first power element 132 and the second power element 134 to charge the first energy storage element 142 and the second energy storage element 144 respectively. The first energy storage element 142 and the second energy storage element 144 are, for example, batteries of various electronic devices.

The current control circuit 120 includes a charging mode detector 122, a current limiting unit 124, a current detector 126 and a switch control unit 128. The power supply 110 can be various types of power such as the power of a computer power or a charger, so the charge mode detector 122 receives an external recognition signal Dx to determine the charging mode and then outputs a charge mode signal CM accordingly. The current detector 126 senses a first charging current IC1 of the first energy storage element 142 and a second charging current IC2 of the second energy storage element 144 by the first current sensor 152 and the second current sensor 154 respectively.

The current limiting unit 124 knows the first charging current IC1 and the second charging current IC2 from the current detector 126. Besides, the current limiting unit 124 makes the sum of the first charging current IC1 and the second charging current IC2 less than or equal to a constant value according to the charge mode signal CM. When the sum of the first charging current IC1 and the second charging current IC2 exceeds the constant value, the current limiting unit 124 outputs a control signal VCx to the switch control unit 128. The switch control unit 128 terminates the second power element 134 to stop charging the second energy storage element 144 temporarily, such that the first energy storage element 142 is charged smoothly.

Referring to FIG. 2, a wave pattern of a charging current of a conventional energy storage element is shown. Whether the current control circuit 120 charges the first energy storage element 142 and the second energy storage element 144 or not is controlled by the switch control unit 128. When the sum of the first charging current IC1 and the second charging current IC2 exceeds the constant value, one of the two power elements 132 and 134 is terminated. Thus, the charging current will carry noises and become extremely unstable as indicated in FIG. 2, not only deteriorating the charging quality but also affecting the lifespan of the energy storage elements 142 and 144 and that of the power supply 110.

### SUMMARY OF THE INVENTION

The invention is directed to a multi charging current control circuit and a method thereof. The charging current is precisely controlled by a close looped circuit to achieve smooth charging.

According to a first aspect of the present invention, a multi charging current control circuit comprising a voltage reference unit, a current limiting unit, a current detector and a current control unit is provided. The voltage reference unit provides many reference voltages. The current limiting unit selects a corresponding reference voltage from the reference voltages according to a charge mode signal and outputs a control signal according to the corresponding reference voltage. The current detector detects a first charging current and a second charging current. The current control unit controls the first charging current and the second charging current according to the control signal. The current detector feedbacks the first charging current and the second charging current detected to the current control unit, such that the current control unit adjusts the first charging current or the second charging current to make the sum of the first charging current and the second charging current less than or equal to a constant value.

According to a second aspect of the present invention, a multi charging current control method is provided. Firstly, a corresponding reference voltage is selected from many reference voltages according to a charge mode signal, and a control signal is outputted according to the corresponding reference voltage. Then, a first charging current and a second charging current are detected. Afterwards, the first charging current or the second charging current is adjusted according to the control signal to make the sum of the first charging current and the second charging current less than or equal to a constant value.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a perspective of conventional charging circuit;

FIG. 2 (Prior Art) is a wave pattern of a charging current of a conventional energy storage element;

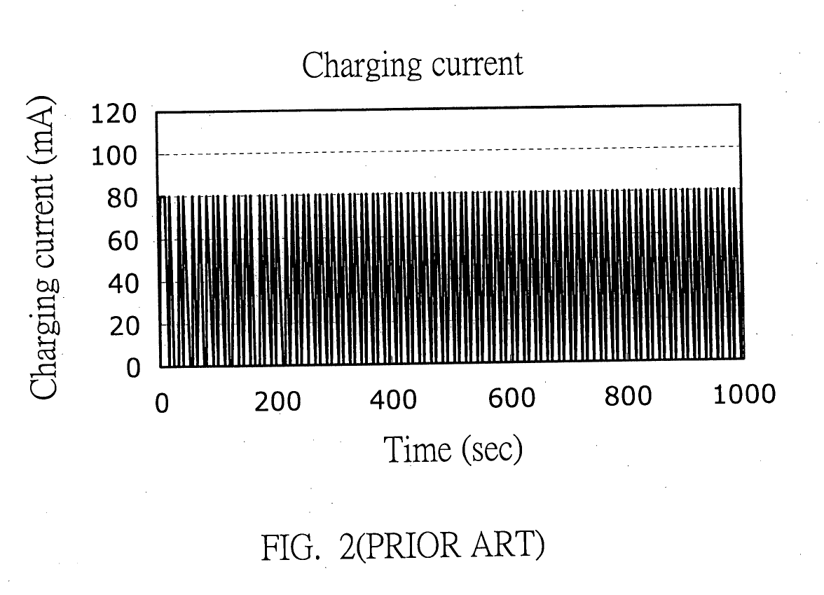

FIG. 3 is a perspective of a multi charging circuit according to a preferred embodiment of the invention; and

FIG. 4 is a wave pattern of a charging current according to a preferred embodiment of the invention.

### DETAILED DESCRIPTION OF THE INVENTION

The invention provides a multi charging current control circuit and a method thereof. The multi charging current control circuit linearly controls a resistor of a power element by a close looped circuit such that the current is charged smoothly and stably. Thus, the energy storage element functionally and safely performs charging without being affected by the change in the characteristics of the power element.

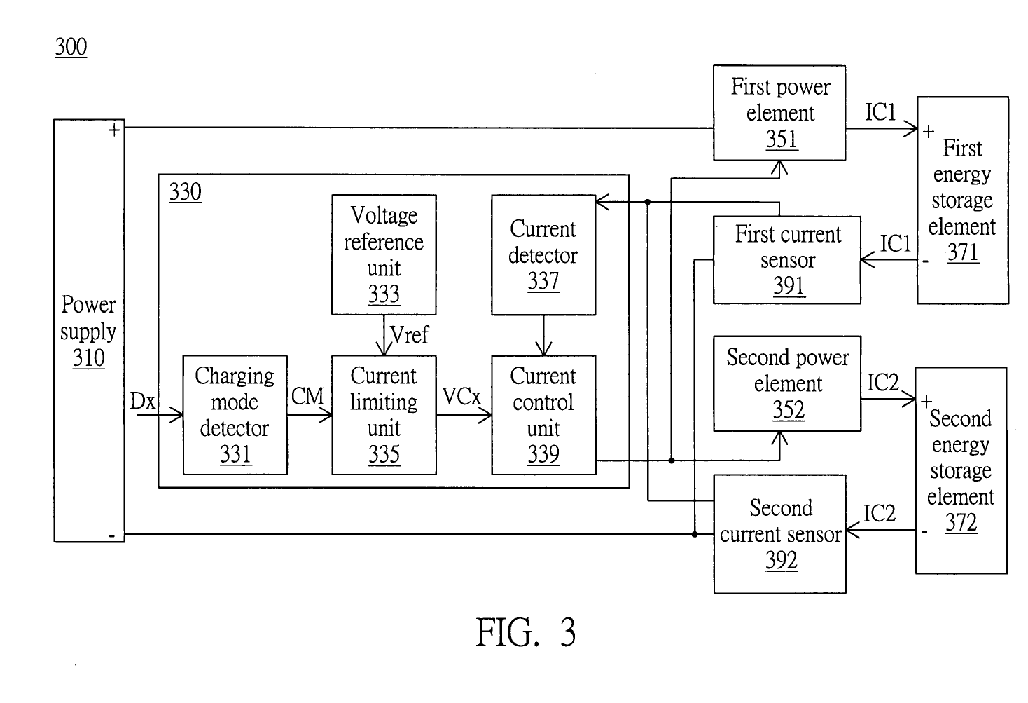

Referring to FIG. 3, a perspective of a multi charging circuit according to a preferred embodiment of the invention is provided. The multi charging circuit 300 includes a power supply 310, a multi charging current control circuit 330, a first power element 351, a first energy storage element 371, a first current sensor 391, a first power element 352, a first energy storage element 372 and a first current sensor 392.

The power supply 310 can be a computer power or a household power provided via an adaptor, and no restriction is imposed. The power supply 310 drives the first power element 351 to generate a first charging current IC1 to charge the first energy storage element 371, and drives the second power element 352 to generate a second charging current IC2 to charge the second energy storage element 372. The first energy storage element 371 and the second energy storage element 372 are batteries of various electronic devices such as the battery of a mobile phone or an MP3 for example. The power supply 310 can charge the first energy storage element 371 and the second energy storage element 372 at the same time, charge one of the first energy storage element 371 and the second energy storage element 372 only, or charge more energy storage elements at the same time, and it is not limited thereto.

The multi charging current control circuit 330 includes a charging mode detector 331, a voltage reference unit 333, a current limiting unit 335, a current detector 337 and a current control unit 339. As the power supply 310 can be various types of power, the charge mode detector 331 receives an external recognition signal Dx which provides relevant information of the power supply 310. Then, the charging mode detector 331 outputs a charge mode signal CM to the current limiting unit 335. The voltage reference unit 333 provides many reference voltages respectively corresponding to one type of powers.

As the power supply 310 is subjected to the restriction of a maximum current, the current limiting unit 335 avoids the burst current being too large. The current limiting unit 335 determines the charging mode corresponding to the power supply 310 according to the charge mode signal CM and selects a corresponding reference voltage Vref from many reference voltages of the voltage reference unit 333. The corresponding reference voltage Vref is related to the types of the power supply 310. For example, when the external recognition signal Dx is outputted from a computer, the corresponding reference voltage Vref corresponds to a computer. Then, the current limiting unit 335 outputs a control signal VCx to the current control unit 339 according to the corresponding reference voltage Vref.

The first current sensor 391 and the second current sensor 392 respectively sense the first charging current IC1 of the first energy storage element 371 and the second charging current IC2 of the second energy storage element 372. The current detector 337 substantially amplifies and operates what the first current sensor 391 and the second current sensor 392 have sensed, and further feedbacks the sensed results to the current control unit 339.

The current control unit 339 receives the control signal VCx outputted from the current limiting unit 335. The control signal substantially limits the first charging current IC1 and the second charging current IC2 to be less than or equal to a constant value to avoid the charging current exceeding the limit of maximum current of the power supply 310, wherein the constant value corresponds to corresponding reference voltage Vref. The current control unit 339 automatically adjusts the first charging current IC1 or the second charging current IC2 according to the information feedbacked from the control signal VCx and the current detector 337 to make the sum of the first charging current IC1 and the second charging current IC2 less than or equal to the constant value.

Let the first energy storage element 371 be the main charging device. When the sum of the first charging current IC1 and the second charging current IC2 exceeds the constant value, the current control unit 339 controls a second resistor (not illustrated in the diagram) inside the second power element 352 to reduce the second charging current IC2 to make the sum of the first charging current IC1 and the second charging current IC2 less than or equal to the constant value. Let the second energy storage element 372 be the main charging device. When the sum of the first charging current IC1 and the second charging current IC2 exceeds the constant value, the current control unit 339 controls a first resistor (not illustrated in the diagram) inside the second power element 351 to reduce the first charging current IC1 to make the sum of the first charging current IC1 and the second charging current IC2 less than or equal to the constant value.

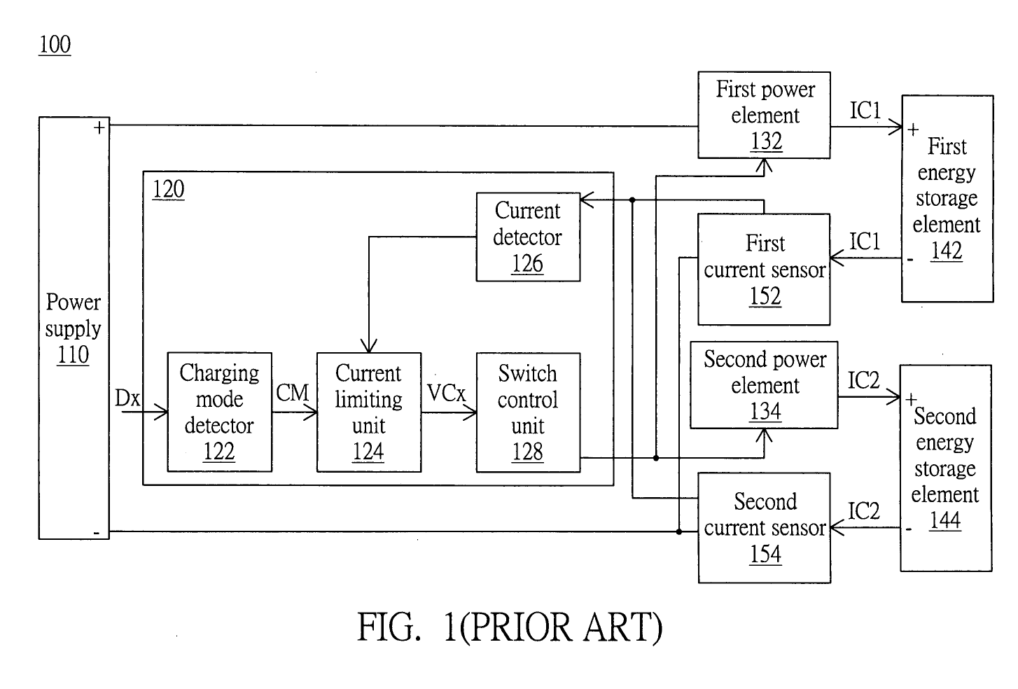

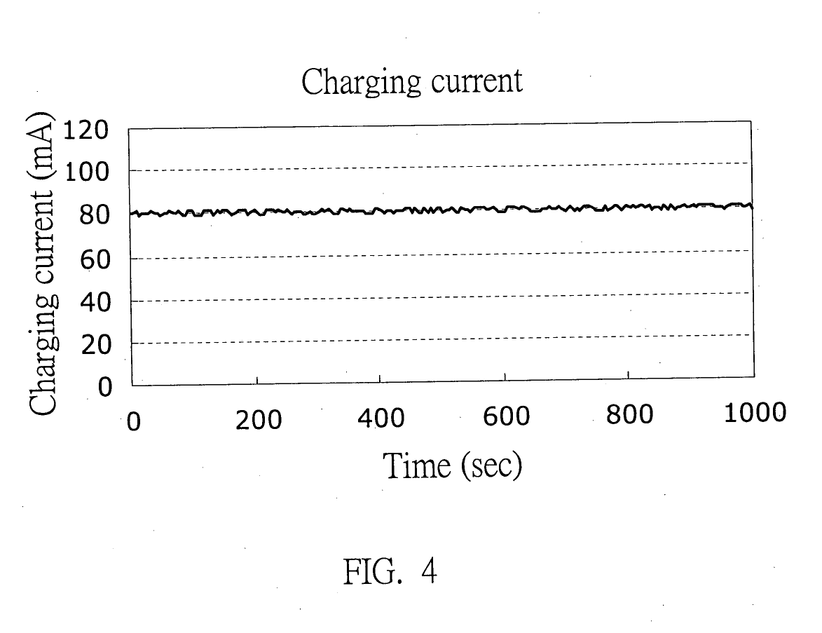

The current control unit 339 replaces the switching of the switch control unit 128 of FIG. 1 with a sophisticated circuit. By controlling the resistor of the power element, the charging current is adjusted linearly, and when the sum of the charging current exceeds a constant value, a part of the charging current is automatically reduced. Referring to FIG. 4, a wave pattern of a charging current according to a preferred embodiment of the invention is shown. As the multi charging circuit 300 forms a stable close loop which will not be broken up by way of switching lin prior art, the cimulti charging circuit 300 can be turned off by way of switching. Therefore, the charging current is stable and free of noises, hence improving charging quality without affecting the lifespan of the energy storage element and that of the power supply 110.

Besides, the charging current is controlled according to a corresponding reference voltage Vref. As the corresponding reference voltage Vref is provided by the voltage reference unit 333 of the multi charging current control circuit 330, and the first power element 351 and the second power element 352 are external driving stages of the multi charging current control circuit 330, the adjustment of the charging current is correct and independent of the change in the characteristics of the first power element 351 and the second power element 352.

According t the multi charging current control circuit and the method thereof disclosed in the above embodiment of the invention, the resistor of the power element is linearly controlled by a close loop multi charging circuit, and an independent reference voltage is used, such that the charging current is stable and will not be affected by the change in the characteristics of the power element. Therefore, the multi charging current control circuit of the invention provides stable and smooth charging currents, hence improving charging quality. Unlike the conventional charging circuit which can only charge one energy storage element when the sum of the charging currents is too large, the multi charging current control circuit of the invention can charge many energy storage elements at the same time and is much more convenient to use.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multi charging current control circuit, comprising:
a voltage reference unit, for providing a plurality of reference voltages;
a current limiting unit, for selecting a corresponding reference voltage from the reference voltages according to a charge mode signal and outputting a control signal according to the corresponding reference voltage;
a current detector, for detecting a first charging current and a second charging current; and
a current control unit, for controlling the first charging current and the second charging current according to the control signal;
wherein the current detector feedbacks the first charging current and the second charging current detected to the current control unit, such that the current control unit adjusts the first charging current or the second charging current to make the sum of the first charging current and the second charging current less than or equal to a constant value.

2. The multi charging current control circuit according to claim 1, wherein the constant value corresponds to the corresponding reference voltage.

3. The multi charging current control circuit according to claim 1, further comprising:
a charging mode detector, for receiving an external recognition signal and outputting a charge mode signal accordingly.

4. The multi charging current control circuit according to claim 3, wherein when the external recognition signal is outputted from a computer, the corresponding reference voltage corresponds to the computer.

5. The multi charging current control circuit according to claim 1, wherein the first charging current is used for charging a first energy storage element, the second charging current is used for charging a second energy storage element.

6. The multi charging current control circuit according to claim 5, wherein the current control unit controls a first resistor of a first power element to adjust the first charging current, and the current control unit controls a second resistor of a second power element to adjust the second charging current.

7. The multi charging current control circuit according to claim 1, wherein the current detector detects the first charging current by a first current sensor and the current detector detects the second charging current by a second current sensor.

8. A multi charging current control method, comprising:
selecting a corresponding reference voltage from a plurality of reference voltages according to a charge mode signal, and outputting a control signal according to the corresponding reference voltage;
detecting a first charging current and a second charging current; and
adjusting the first charging current or the second charging current according to the control signal to make the sum of the first charging current and the second charging current less than or equal to a constant value.

9. The multi charging current control method according to claim 8, wherein the constant value corresponds to the corresponding reference voltage.

10. The multi charging current control method according to claim 8, further comprising:
receiving an external signal to obtain a charge mode signal.

11. The multi charging current control method according to claim 8, further comprising:
charging a first energy storage element by the first charging current and charging a second energy storage element by the second charging current.
